(19) United States
(12) Patent Application Publication
(10) Pub. No.: US 2023/0313725 A1
(43) Pub. Date: Oct. 5, 2023

(54) CIRCULAR EXHAUST-DIFFUSER SYSTEM

(71) Applicants: Alexander PKHAKADZE, Nafplio (GR); Luka PKHAKADZE, Nafplio (GR)

(72) Inventor: Alexander PKHAKADZE, Nafplio (GR)

(21) Appl. No.: 18/022,977

(22) PCT Filed: Aug. 23, 2021
(86) PCT No.: PCT/GR2021/000056

§ 371 Date: Feb. 23, 2023

(30) Foreign Application Priority Data
Aug. 24, 2020 (GR) 20200100510

(51) Int. Cl. F01N 13/08; F01N 3/05

(52) U.S. Cl. CPC F01N 13/082; F01N 3/05; F01N 2270/08; F01N 2470/10

(57) ABSTRACT

The invention is a circular system with an integrated exhaust-diffuser that reveals an inlay construction of an air passage similar to a tunnel. The present invention through use of aerodynamics, completely releases the exhaust gas and soot layer from the system. It consists of three main parts: the receptacle chamber, the outer frame and the inner frame, which make up the whole construction. The exhaust gas entering the receptacle chamber is split in two and then it heads to the main body (5), where from a viscous form it turns to a sparse-thin form, then the compressed exhaust gas exits to the air tunnel through the slot (6). Above the slot, a short distance away is the stabilizer (3). The stabilizer (3) by compressing the exhaust air mixtures with high pressure is then mixed at the rear of the vehicle with ambient air inside the tunnel. When the vehicle is moving and developing high speed, the air-exhaust mixture is easily merged and the invention that way effectively removes exhaust gases from the system.

### FIELD OF THE INVENTION

The invention is a circular exhaust-diffuser system for internal combustion engines. The main essence of this combination is to convert the thick flow of exhaust gas into a thin form and mix it with fresh air.

### SUMMARY OF THE INVENTION

Incomplete release of exhaust gas from the combustion chamber and exhaust system results in poor fuel combustion and the production of harmful gases, so a layer of soot remains on the pipe walls, clogging the filters and catalysts and destroying the components in the diesel engine.

The present invention eliminates this problem by using natural resources and minimizes mechanical defects through aerodynamic use.

The circular exhaust-diffuser system is placed at the rear and bottom of the vehicle floor and is practically a duct of increasing cross-section.

The circular exhaust-diffuser system has a trapezoidal shape and in the middle an empty space like a tunnel which is divided by partitions. In this space, the air-exhaust gas mixture is merged.

Apart from the fact that the system has a trapezoidal shape with an empty conductive space separated by partitions, the trapezoidal shape as a frame is the main body of the structure.

The main body of the trapezoidal shape of the system is the exhaust duct where the exhaust gas is delivered from the receiving chamber. The intake chamber has an inlet pipe from which the engine is discharged and after passing through the mufflers the exhaust gas is poured into the invention.

The intake chamber is a closed box. A separator is integrated in the exhaust pipe to separate the exhaust gas and to direct the separated exhaust flow in different directions. The intake chamber is mounted on the main body and has two openings at the bottom to allow the exhaust gas to escape from the separators. From this opening, the main body is supplied with exhaust gas in the opposite direction.

The main body has an internal free space around the perimeter of both the base lengths and the side slopes, which is filled with exhaust gas coming from the intake chamber. Also in this internal free space the exhaust gas flow is converted into a flat substance and such an impact also increases the exhaust gas flow pressure.

The construction has a trapezoidal shape, its axial length is less than the longitudinal length. For the exhaust-diffuser, the front and the rear are considered free space with partitions where the mixture of atmospheric air and the exhaust gas is mixed.

In addition to trapezoidal design, it has pointed edges to make it more aerodynamic. The construction of this shape is achieved by the following means. The frame of a trapezoidal shape is composed in such a way that its outer perimeter is larger than its inner perimeter. The difference in this kind of constraint between them creates the small empty space that is considered to be the empty space of the main body. Also the axial length of the outer perimeter is greater than the axial length of the inner perimeter.

Such perimeter data characterize the outer and inner perimeter of the trapezoidal structure, their symmetrical connection forms the pointed edges and the empty closed space created in the main body arises from the inner and outer surfaces of the wall.

The circular exhaust diffuser, which has a trapezoidal shape, is a duct that looks like a tunnel with partitions and in its main body the exhaust gas is taken from the receiving chamber. The separated exhaust gas flows through the separator in the opposite direction to the main body and in the circular circuit merges with each other again, causing an increase in pressure as the exhaust gas flows continuously into the system because the engine is running.

The entire perimeter of the interior of the structure is accompanied by a slot so that the direction of release of the exhaust gas is directed to the rear of the car with an internal combustion engine.

The slot, which is located around the perimeter of the structure, is an important point of action. From here flows a narrow and thin layer of exhaust gas throughout the inner perimeter. This slot in the invention emerges from the following means.

The inner perimeter of the structure is cut along the entire length of the perimeter so that a certain part of the inner perimeter from the front of the structure is covered by a certain part of the back of the inner perimeter.

The rear part covered by the front part do not touch each other and such a reciprocal position creates a narrow channel around the perimeter, which is an efficient means of exhaust gas removal and also gives the exhaust gas a thin and diluted shape.

To complete the exhaust gas removal from the slot, a stabilizer accompanies the slot a short distance around the perimeter.

The stabilizer is a narrow thin plate and accompanies the slot. The role of the stabilizer is to direct the flow of outside air more strongly to the exhaust vent vacuum and thus enhance the removal of the exhaust gas from the system.

### BRIEF DESCRIPTION OF THE DRAWINGS

A brief explanation of the invention by means of drawings:

FIG. 1. Shows a circular exhaust diffuser from the front where (1) is the pipe through which the exhaust gas is fed to the receiving chamber. Arrow A is the exhaust gas and arrow B is the atmospheric air passing under the car.

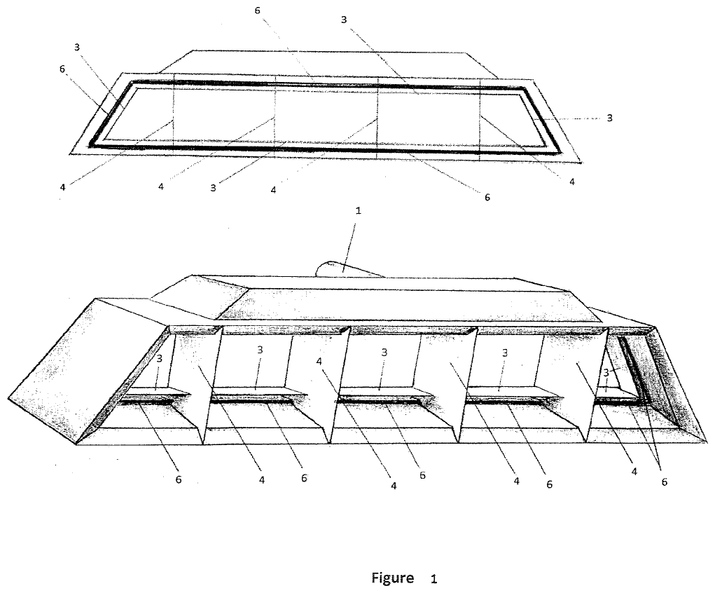

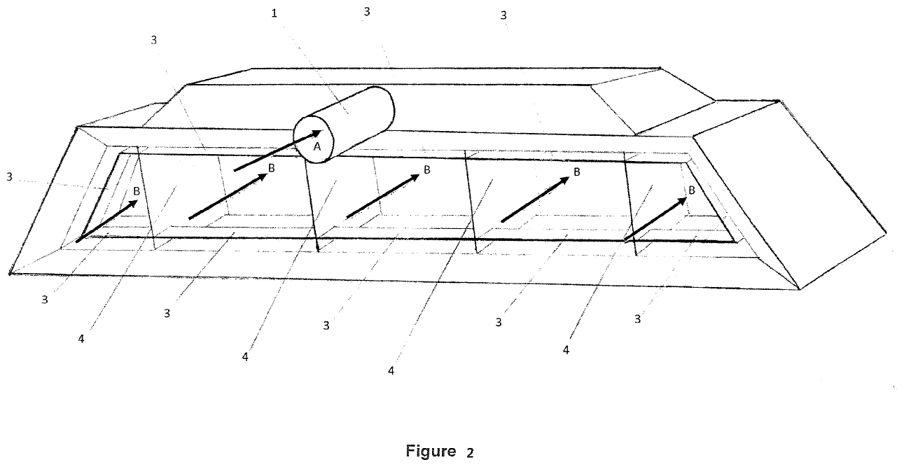

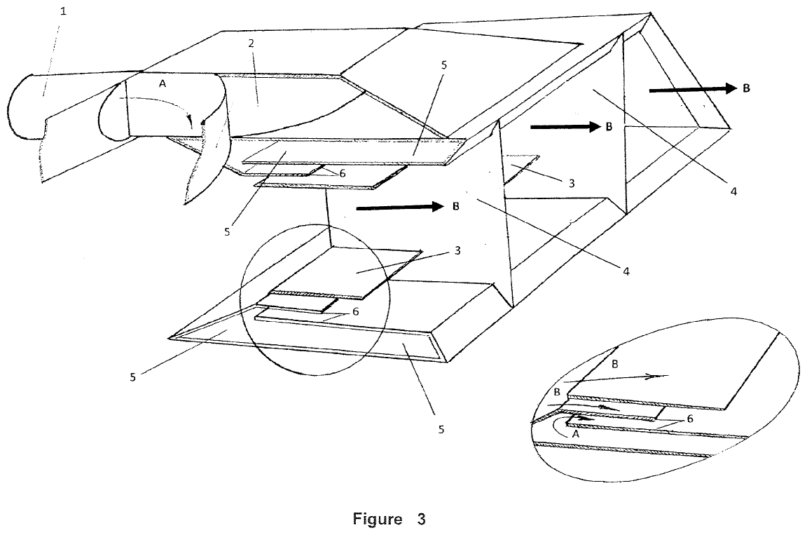

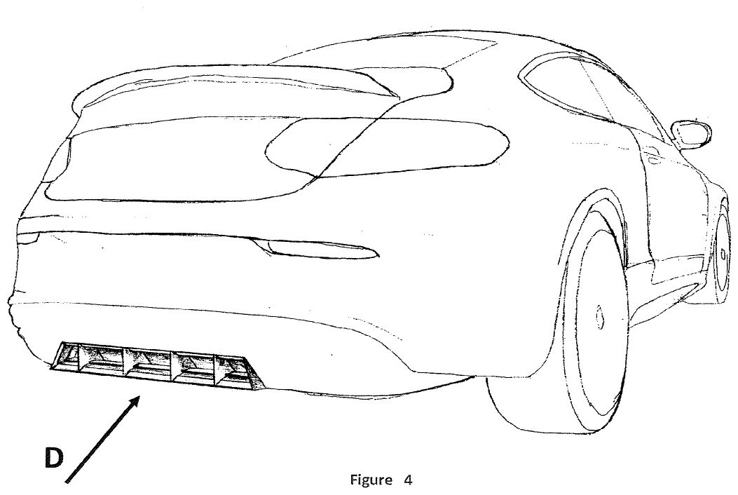

The second drawing, which is numbered 2., illustrates the back of the invention, where a bold line shows the trapezoidal shape and the number 6 indicates the slot from which the exhaust gas flows in a thin form. Also the number 4 are the partitions that are in the free space where the atmospheric air and the exhaust gas are mixed.

A more detailed explanation of the construction is shown in FIG. 3. The circular exhaust diffuser shown in this figure is shown in half section and shows in detail how the system is fed from the pipe (1) to the separator located in the receiving chamber (2).

The reception chamber located above the trapezoidal structure, in the free space of the main body (5) feeds the exhaust gas. The section also shows the vacuum (6), which is located around the perimeter and is the best channel for the exhaust that allows the exhaust gas to get a thin circuit.

Partitions (4) which are at the same time a directional guide for the ambient air and an important part of the structure. In this case the construction has four partitions, its number does not matter much as it can be three or five.

FIG. 3. shows the stabilizer (3) located near the slot (6) which accompanies the entire perimeter of the slot and through it increases the pressure of the atmospheric air flow which will affect the improvement of the exhaust gas outflow. It is also important that the space between the partitions (4), where the atmospheric air passes as shown in arrow B, is large enough and that the air flow during a moving car is also sufficient.

The letter D indicates a circular exhaust diffuser. It is located in the vehicle shown in FIG. 4. This location is important for the construction as a large amount of ambient air flows from this area, which can significantly affect the exhaust emissions.

1. Circular exhaust system-diffuser mounted on the rear and bottom of floors (D) of vehicles with internal combustion engines, which is practically a duct of increasing cross-section and consists of a trapezoidal frame which is the main body with an empty space (5) in the middle that looks like a tunnel, with the frame being composed in such a way that its outer perimeter is larger than its inner perimeter and the difference in this kind of restriction between them creates the small empty space that is considered to be the empty space of the main body (B), which is divided into partitions (4) for the purpose of merging a mixture of ambient air with exhaust gas and also has pointed edges to make it more aerodynamic.

2. A circular exhaust-diffuser system according to claim 1, comprising of an exhaust gas supply pipe (1) and furthermore a separator (2) which is integrated in the receiving chamber to separate the exhaust gas (A) and to direct the separated exhaust flow in different directions.

3. A circular exhaust-diffuser system, according to claims 1 and 2, further comprising an exhaust intake chamber which is a closed box, mounted on the main body and having two openings at the bottom to allow the exhaust gas to escape through the separator.

4. Circular exhaust-diffuser system, which according to the preceding claims, has an internal free space (5) in the main body around the perimeter of both the base lengths and the side slopes, which is filled with exhaust gases (A) coming from the receiving chamber and also in this internal free space the exhaust gas flow is converted to a flat substance and with such a collision it increases the exhaust gas flow pressure.

5. Circular exhaust-diffuser system, according to the preceding claims comprising a slot (6) which accompanies the entire inner perimeter and aims at the directional release of the exhaust gas towards the rear of the vehicle with an internal combustion engine.

6. Circular exhaust-diffuser system, according to claim 1 comprising the inner perimeter of the structure which is cut along the entire length of the perimeter so that a certain part of the inner perimeter from the front of the structure is covered by a certain part of the rear of the inner perimeter, with the part of the rear covered by the front part not touching each other and from this mutual position a narrow channel is created around the perimeter, which is an effective means of exhaust and also gives the exhaust gas a thin and sparse shape.

7. Circular exhaust-diffuser system, according to the preceding claims comprising a stabilizer (3), a narrow thin plate accompanying the slot (6) at a short distance around the perimeter for complete evacuation of the exhaust gases from the slot.
